(19) United States
(12) Patent Application Publication
(10) Pub. No.: US 2005/0259223 A1
(43) Pub. Date: Nov. 24, 2005

(54) Projection display

(76) Inventor: Nicholas C. Hopman, Lake Zurich, IL (US)

Correspondence Address: MOTOROLA, INC., 1303 EAST ALGONQUIN ROAD, IL01/3RD, SCHAUMBURG, IL, 60196, US

(21) Appl. No.: 10/851,413

(22) Filed: May 21, 2004

(51) Int. Cl. G03B 21/00

(52) U.S. Cl. 353/13

(57) ABSTRACT

A device and method for projecting a first collimated light wave section 110 onto a diffusing surface 115 traversing along a first path d₁ 120 forming a first image, and projecting a second collimated light wave section 135 formed along a second path d2, d3, d4, 140 commencing at the collimated light source 105, directed by first 145 and second 150 specular surfaces, and terminating on a second portion 155 of the diffusing surface 115 forming a second image, wherein the length of the first path d₁ 120 is different than the length of the second path d2, d3, d4, 140.

### FIELD OF THE INVENTION

The present invention relates generally to displays, and more specifically, to projection displays that display on more than one surface simultaneously.

### BACKGROUND OF THE INVENTION

Projection displays are useful for displaying information on diffusing surfaces, and in other cases as virtual images displayed through surfaces—such as in a Head Up Display (HUD) configuration. Largely projection displays are constructed using a light source to project onto a single surface. If a single projection display is adapted to display on more than one surface simultaneously, and these surfaces have differing lengths, only one image will be in focus if the initial light source is diffused as in a typical projection display.

What is needed is an improved display method and system that can display different images on surfaces having different lengths, or distances between the light source and the display surfaces, using a single projector.

### BRIEF DESCRIPTION OF THE DRAWINGS

FIG. 1 is a schematic diagram of a projection display in accordance with a first embodiment of the invention;

FIG. 2 is a schematic diagram of a projection display in accordance with a second embodiment of the invention;

FIG. 3 is a schematic diagram of a projection display in accordance with a third embodiment of the invention;

FIG. 4 is a schematic diagram of a projection display in accordance with a third embodiment of the invention; and

FIG. 5 illustrates a specific use case for an in-vehicle projection display in accordance with the embodiments disclosed herein.

### DETAILED DESCRIPTION OF THE PREFERRED EMBODIMENT

In the embodiments that follow a device and method are detailed that enable the display of images on surfaces having different lengths using a single projector. This is preferably accomplished using a projection light source with a collimated light source. Preferably the light source is a LASER, or several LASERs. Single-mode LASERs are particularly good because they remain in focus from a short distance to a very long distance. This infinite-focus is particularly beneficial when projecting onto diffusing surfaces of differing optical path lengths. Moreover since LASERs produce a coherent collimated emission there is substantially no optical power loss when transmitted through air to a diffusing surface. Use of multi-mode LASERs is also possible. One advantage of multi-mode LASERs is the relatively high optical power output compared to single-mode LASERs. Since multi-mode LASERs produce light that is not coherent and not as collimated as a single-mode LASER additional optical elements may need to be inserted in the optical paths described below for optimal results. Both single-mode and multi-mode LASERs produce light at a specific wavelength and thus provide monochromatic light.

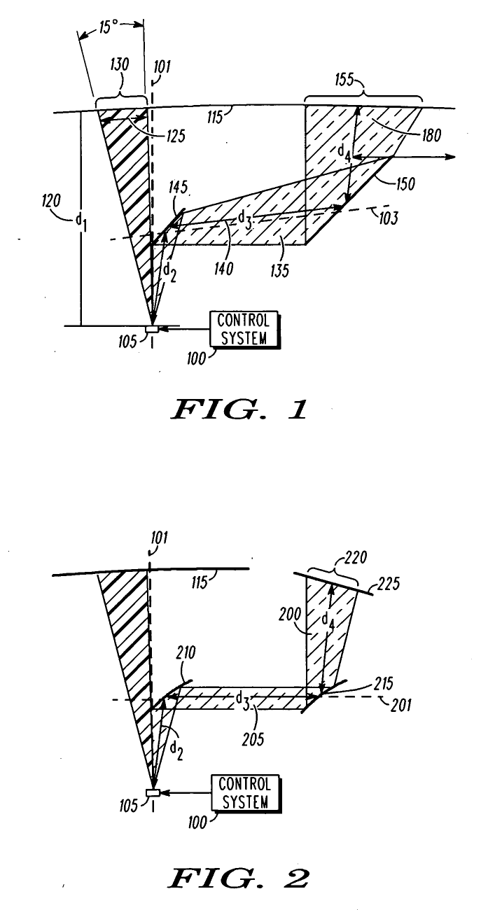

Referring to FIG. 1, a control system 100 drives a collimated light source 105, such as a LASER, that projects a first collimated light wave section 110, oriented along a first axis 101, onto a diffusing surface 115 forming a first image. The diffusing surface 110 may be any surface with an ability to diffuse the first collimated light wave section 110. For example the diffusing surface 115 could be a vehicle windshield with a diffusing surface treatment. One type of diffusing surface 115 may include a hologram that allows light in, so a driver can see the road in front of the car, but also sees the diffused first collimated light wave section 110, which contains information projected by the LASER 105. Alternatively, the diffusing surface 115 can be another flat or curved surface such as a dashboard, a rear portion of a seat or any other surface that allows light to diffuse.

Preferably, the control system 100 sources the LASER 105 with a useful pattern, such as vehicle speed information onto the diffusing surface 115. As the first collimated light wave section 110 traverses along a first path d₁ 120 between the LASER 105 and the diffusing surface 115 it disperses or diverges at a first prescribed angle 125; here 15°. Because of this dispersion along first path d₁ 120 a diffused image appears approximately perpendicular to the first path d₁ 120 formed on a first portion 130 of the diffusing surface 115. Note that if the first path d, 120 increases that the first portion 130 of the diffusing surface 115 that the diffused image appears on will increase in dimension.

A second collimated light wave section 135 is formed along a second path 140 d₂, d₃, d₄, oriented along a second axis 103, commencing at the collimated light source 105, directed by first 145 and second 150 specular surfaces, and terminating on a second portion 155 of the diffusing surface 115 forming a second image. Note that the second axis 103 is not perpendicular to the first axis 101. This is because the first 145 specular surface is flat causing the second collimated light wave section 135 to diverge at a non-perpendicular angle compared to the first collimated light wave section 110. Also, as the second collimated light wave section 135 deflects off of the first specular surface 145 it continues to diverge or spread. Note that the specular surfaces 145, 150 may be constructed of a mirror, a beam splitter, a reflection holographic device or any other device having reflective properties. As the second collimated light wave section 135 deflects off of the second specular surface 150 it continues to diverge or spread at a second prescribed angle 160 until it terminates on the diffusing surface 115. Because of these divergences the distance covered by the second portion 155 is necessarily larger than the distance covered by the portion 130 on the diffusing surface 115. This may be desirable in some cases and not desirable in others. Note that the LASER light source 105 could be monochromatic or color. To produce color more than one LASER is needed. Preferably a red, green and blue LASER are used which will produce a full color image.

A second embodiment is illustrated in FIG. 2. Another collimated light wave section 200 is formed along another path 205 d_{2′}, d_{3′}, d_{4′}, oriented along another axis 201, commencing at the collimated light source 105, directed by first 210 and second 215 curved specular surfaces, and terminating on another portion 220 of another diffusing surface 225. Note that as the another collimated light wave section 200 deflects off of the first curved specular surface 210 it continues to diverge or spread. Note that the curved specular surfaces 210, 215 may be constructed of a mirror, a beam splitter, a reflection holographic device or any other device having reflective properties. As the another collimated light wave section 200 deflects off of the second specular surface 215 it again diverges or spreads at another prescribed angle along an axis 210, substantially perpendicular the first axis 101 until it terminates on the diffusing surface 225. It is the geometry of the first 210 curved specular surface that contains the light wave section 200 into a column. This is a great advantage because it allows a relatively long transition path for the light wave section 200 without the light wave section 200 growing in size. The second 215 curved specular surface allows the light to spread to create a larger display area. This spreading could be contained by using a flat specular surface 150 shown in FIG. 1. Note also in FIG. 2 that the diffusing surfaces 101 and 225 are not on the same surface as in FIG. 1. Note that although FIG. 1 and FIG. 2 show plan-views of the surfaces 115, 145, 150, 210, 215, and 225, these surfaces are actually 2 dimensional. Also the light wave sections 110, 135, and 205 are three-dimensional. Because of this the surfaces 145, 150, 210, and 215 may be oriented in a spherical manner so as to confine the paths 140, 205 to a fixed elevation.

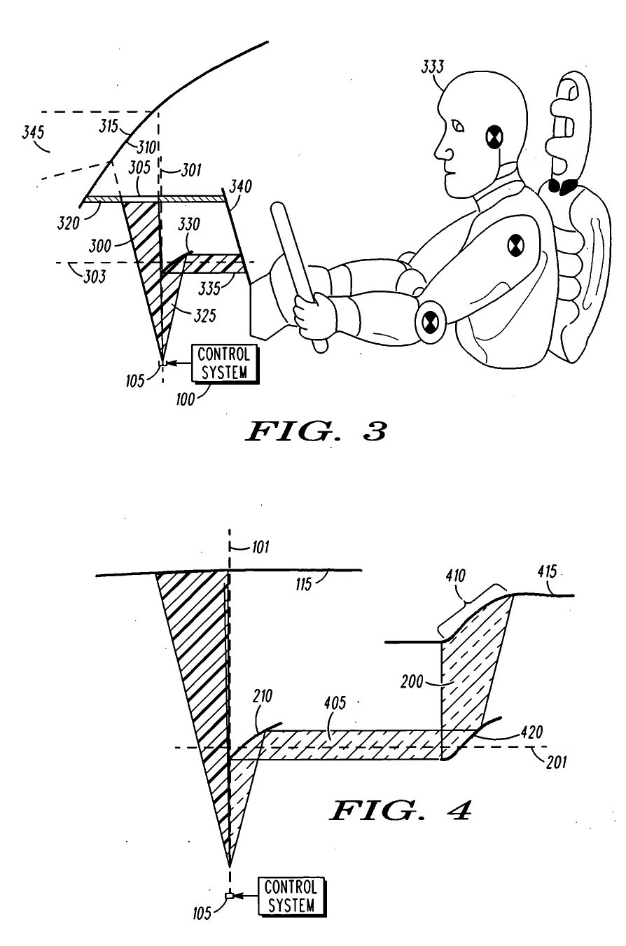

A third embodiment is illustrated in FIG. 3. A collimated light wave section 300 is formed oriented along an axis 301, commencing at the collimated light source 105, and terminates on a diffusing element 305 embedded in a dashboard 320. The purpose of the diffusing element 305 is to form an image for projection onto a first side 310 of a windshield 315. Once formed the image is viewable as a virtual image 345 on a side opposite the first side 310 of the windshield 315. This function is often called a Head-Up Display or HUD. Preferably, the windshield 315 includes an optical element, such as an optical wedge, a holographic element or other means for correcting for a double image naturally formed by a windshield having a finite thickness. Optionally the hologram can have other properties as desirable.

Another collimated light wave section 325 is formed oriented along the axis 301, commencing at the collimated light source 105, reflecting off a curved specular surface 330 directing the collimated light wave section 325 along another axis 303 substantially perpendicular to the axis 301, forming a non-diverging collimated light section 335, and terminating on a diffusing surface 340. This structure forms an instrumentation panel. Both the HUD and the instrumentation panel are viewable by a driver 333. Note that the curved specular surface 330 converges the spreading collimated light wave section 325 into a non-diverging collimated light section 335. This is very useful for transporting a light wave section over a relatively large distance without the spreading of the light pattern. This is particularly useful as the distance traversed between a light source and diffusing surface increases. In a vehicle this is very useful for creating multiple images on a windshield using a single projection device. This particular case is shown in FIG. 1, except in this illustration the light wave diverges.

In FIG. 4 a non-planar surface 415 is introduced. A collimated light wave section 405 is formed oriented along the axis 201, commencing at the collimated light source 105, and terminating on a portion 410 embedded of the non-planar surface 415. Ordinarily, if the projection source 105 is projected directly onto the non-planar surface 415, the resulting image would be distorted. So as not to geometrically distort the information contained in the collimated light wave section 405 a shaped specular element 420 is introduced into the optical path between the collimated light source 105 and the a portion 410 embedded of the non-planar surface 415. To mitigate geometric distortion the geometric shape of the specular element 420 corresponds the geometric shape of the portion 410 embedded of the non-planar surface 415. With the described structure, the image projected on the surface 415 appears to be the same as if the surface 415 was flat because the shaped specular element 420 corrects for distortion causable by the shape of the surface 415. Note that even that although only a plan-view is shown the surface 415 and the corresponding shaped specular element 420 can also have complementary shapes in other views.

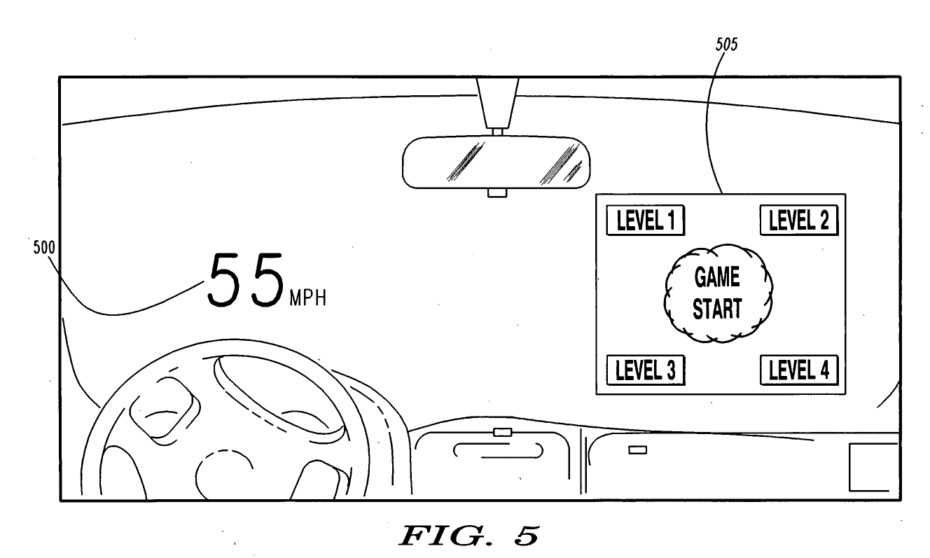

FIG. 5 illustrates a specific use case for an in-vehicle projection display. Here a Head Up Display (HUD) image is shown 500 on a windshield. Also a game console display is shown 505 on a separate portion of the windshield. The embodiment in FIG. 2 is used to project these displays from a single projector. This embodiment is desirable to contain the spreading of the collimated light wave sections over the relatively large horizontal display distances shown here. The embodiment shown in FIG. 4 could be used if the game console display were displayed on the dashboard which is a non-planar surface.

An improved display method and system has been detailed that can display different images on surfaces having different lengths, or distances between the light source and the display surfaces, using a single projector.

1. A collimated source projection display comprising:
a collimated light source projecting a first collimated light wave section onto a diffusing surface traversing along a first path d₁ forming a first image, and projecting a second collimated light wave section formed along a second path d2, d3, d4, commencing at the collimated light source, directed by first and second specular surfaces, and terminating on a second portion of the diffusing surface forming a second image, wherein the length of the first path d₁ is different than the length of the second path d2, d3, d4.

2. A device in accordance with claim 1 wherein the collimated light source is monochromatic.

3. A device in accordance with claim 1 wherein the collimated light source comprises at least one coherent light source.

4. A device in accordance with claim 1 wherein the collimated light source comprises a plurality of monochromatic light sources.

5. A device in accordance with claim 1 wherein the collimated light source comprises a plurality of monochromatic coherent light sources each of substantially different wavelengths.

6. A device in accordance with claim 5 wherein the plurality of monochromatic coherent light sources comprises a corresponding plurality of LASERs.

7. A device in accordance with claim 2 wherein the LASER is a single-mode LASER.

8. A device in accordance with claim 2 wherein the at least one collimated light source comprises a LASER.

9. A device in accordance with claim 1 wherein the first collimated light wave section diverges at a first prescribed angle, and the second collimated light wave section diverges at a second prescribed angle different than the first prescribed angle.

10. A device in accordance with claim 1 wherein the diffusing surface is a windshield of a vehicle.

11. A device in accordance with claim 10 wherein the diffusing surface comprises a hologram coupled to the windshield.

12. A device in accordance with claim 1 wherein the first collimated light wave section diverges as it transits along the first path d₁, and wherein at least one of the first and second specular surfaces is curved causing the second collimated light wave section not to diverge while it traverses along the second path d2, d3, d4.

13. A collimated source projection display comprising:
a first specular surface;
a second specular surface oriented facing the first specular surface;
a first diffusing surface;
a second diffusing surface oriented separate from the first diffusing surface; and
a collimated light source for projecting a first collimated light wave section onto the first diffusing surface traversing along a first path d₁ forming a first image, and projecting a second collimated light wave section formed along a second path d2′, d3′, d4′ commencing at the collimated light source, directed by first and second specular surfaces, and terminating on a portion of the second diffusing surface forming a second image, wherein the length of the first path d₁ is different than the length of the second path d2, d3, d4, and wherein at least one of the first and second specular surfaces are curved.

14. A device in accordance with claim 13 wherein the collimated light source comprises at least one coherent light source.

15. A device in accordance with claim 14 wherein the at least one coherent light source comprises a single-mode LASER.

16. A device in accordance with claim 14 wherein the at least one coherent light source comprises a multi-mode LASER.

17. A device in accordance with claim 13 wherein the first collimated light wave section diverges at a first prescribed angle, and the second collimated light wave section diverges at a second prescribed angle different than the first prescribed angle.

18. A device in accordance with claim 13 wherein the first collimated light wave section diverges as it transits along the first path d₁, and wherein the portion of the second diffusing surface is non planar shape and at least one of the first and second specular surfaces has a shape corresponding to the non planar shape of the portion of the second diffusing surface.

19. A method of projecting images from a collimated light source comprising the steps of:
projecting a first collimated light wave section onto a diffusing surface traversing along a first path d₁ forming a first image; and
projecting a second collimated light wave section formed along a second path d2, d3, d4, commencing at the collimated light source, directed by first and second specular surfaces, and terminating on a second portion of the diffusing surface forming a second image, wherein the length of the first path d₁ is different than the length of the second path d2, d3, d4.
